(19) United States
(12) Patent Application Publication
(10) Pub. No.: US 2006/0083028 A1
(43) Pub. Date: Apr. 20, 2006

(54) Light guide plate and method for fabricating the same

(76) Inventors: Yi-Ting Sun, Hsinchu (TW); Hwa-Tang Lai, Hsinchu (TW); Po-Hung Yao, Hsinchu (TW); Yu-Nan Pao, Hsinchu (TW)

Correspondence Address: RABIN & BERDO, P.C., Suite 500, 1101 14th Street, N.W., Washington, DC, 20005, US

(21) Appl. No.: 11/038,261

(22) Filed: Jan. 21, 2005

(30) Foreign Application Priority Data
Oct. 19, 2004 (TW) 093131636

(51) Int. Cl. F21V 7/04

(52) U.S. Cl. 362/615

(57) ABSTRACT

A light guide plate and method for fabricating the same are proposed. An injection molding process is performed to form at least an arc-shaped first opening portion on the light guide plate, so that a concave lens structure is formed on an edge of the first opening portion to be in line with a light source. By such arrangement, the concave lens structure can direct light and achieve a uniform light dispersion effect.

### FIELD OF THE INVENTION

The present invention relates to a light guide plate and a method for fabricating the same, and more particularly, to a light guide plate and a method for fabricating the same applicable to a backlight module.

### BACKGROUND OF THE INVENTION

Along with the booming development of a light source such as a light emitting diode (LED) which has been massively used as a backlight source in car lights, advertising light boxes and light guide plates, the LED light source has been identified as a trend for the future development of illumination. Referring to the dramatic growth of applications of a LED light source in a backlight module, in order to meet the requirement of environmental protection and miniaturization for the backlight source of the backlight module, it is desirable to replace a line source, a cold-cathode fluorescent tube (CCFT) source, with a discrete or point-like source such as the LED.

The backlight module mainly comprises a light source (such as the LED), a light guide plate, a diffusion sheet and a brightness enhancement film. A spontaneous light source is directed by the light guide plate to generate a larger and more uniform light source. The structure of the light guide plate is of particular importance as the light guide plate is considered as the main technique and cost of the backlight module, and optical design and light output brightness and uniformity all depend on design and fabrication of the light guide plate.

The design of a current light guide plate structure can refer to fabrication of net points or V-shaped notches on a bottom of the light guide plate. In general, the light output brightness of the light guide plate having the V-shaped notch on the bottom thereof is better than that of the light guide plate having the net point on the bottom thereof when the same light source is used. On the contrary, if the LED is used as the backlight source for the light guide plate, the light guide plate having the V-shaped notch on the bottom thereof will have an obviously bright band image appeared at the beginning of LED light emission and along the direction of the light emission, such that the light output uniformity of the light guide plate is very inconsistent.

In light of the drawback of the foregoing bright band image, the V-shaped notch is usually fabricated on a light incidence surface where light emitted from the LED light source enters the light guide plate. Referring to FIG. 8, a LED light source 100 is dispersed by a V-shaped notch 101 of a light guide plate 10 after propagating through the V-shaped notch 101.

However, as the contour of the foregoing V-shaped notch is of a regular structure, parallel light of the same direction and different light incident positions still has the same incident angle. In other words, the light source dispersed by the V-shaped notch 101 is usually re-directed into a few certain directions, so as to affect the light output uniformity on other portions of the light guide plate.

Furthermore, referring to a method of fabricating the V-shaped notch 101 shown in FIG. 8, fabrication of two molds is required. First of all, V-shaped notches are sculptured on one side of one mold and on a bottom of the other mold. Then, a light guide plate having the V-shaped notch provided on a side thereof is formed after performing an injection molding process of these two molds, such that the V-shaped notch can serve as a light incidence microstructure. The light incidence microstructure fabricated using such method, however, requires fabrication of two molds, so as to require a relatively higher cost.

Moreover, it is impossible to fabricate a complex microstructure for light dispersion, such as an arc shape or an irregular curved design, if the microstructure is fabricated on the mold using a mechanical processing method. Therefore, when the mechanical processing method is employed to directly fabricate the microstructure on the light guide plate, shapes or dimensions of the microstructure are both limited. Theoretically, such prior-art technique is not able to achieve a design which provides a better light dispersion effect.

Referring to FIG. 9, a design of a light guide plate using a LED as a light source has been recently disclosed in SID 03 (S. M. Lee, H. W. Choi, SID 03 DIGEST). A light guide plate 20 in combination with a concave lens 201 and a prism 203 are able to form a collimated light beam using a point-like source such as the LED. The light source emitted from the LED is dispersed by the concave lens 201 to provide a large distribution of the light source. Subsequently, the light source dispersed by the concave lens 201 is collimated by the prism 203, such that the light source which eventually enters the light guide plate 20 becomes collimated light which distributes in a large area. However, fabrication of the prism is difficult and such technique thus does not allow fast mass production and requires a relatively higher cost.

Furthermore, U.S. Pat. No. 6,568,822 B2 has disclosed a linear illumination source, by which an incident light source is dispersed to provide substantially uniform illumination of a light guide plate. Referring to FIG. 10A, a light guide plate 30 comprises a curved cavity 301 and a prismatic structure 303. After the light source is entered, the light source is dispersed by the curved cavity 301 and subsequently collimated to illuminate a target plane 305. FIG 10B shows a light incidence microstructure 301′ having a non-hemispherical camber and illustrates the correlation between dimensions of the microstructure 301′ and light output distribution.

The design of light incidence curved surfaces described in the U.S. Pat. No. 6,568,822 B2 is of a non-spherical curvature and thus does not allow mass production in actual situations. Therefore, the technique disclosed in such patent neither allows mass production nor reduces a cost due to complicated fabrication.

Moreover, U.S. Pat. No. 6,139,163 has disclosed a planar light source unit, by which light beams are continuously reflected and refracted before entering into an interior of a light guide plate. Referring to FIG. 11, a light guide plate 40 comprises a semicircular cavity 401 and a plurality of holes 403 having a triangular shape. The semicircular cavity 401 is formed in an edge of the light guide plate 40 for incidence of a light source. The hole 403 having a triangular shape is formed in the light guide plate 40 at a position opposite to the light source for reflecting light beams emitted from the light source.

However, referring to U.S. Pat. No. 6,139,163, the light beam emitted from the light source needs to be reflected and refracted for a number of times before entering into the interior of the light guide plate, such that light energy is dramatically lost and a light output is reduced as a result. Additionally, the structure of the light guide plate disclosed by such patent is very complex and might not be produced in actual situations, and therefore might not comply with economic efficiency.

The problem to be solved here, therefore, is to provide a light guide plate and a method for fabricating the same, by which prior-art drawbacks such as light output non-uniformity, a high cost, a dramatic loss of light energy and a low utilization value in production can be eliminated. Further, the light guide plate and the method for fabricating the same proposed in the present invention are capable of improving design flexibility, reliability and light dispersion effect of the light guide plate with a relatively lower cost.

### SUMMARY OF THE INVENTION

In light of the above prior-art drawbacks, a primary objective of the present invention is to provide a light guide plate and a method for fabricating the same, so as to achieve a light guidance and uniform light dispersion effect.

Another objective of the present invention is to provide a light guide plate and a method for fabricating the same, so as to reduce a fabrication cost.

Still another objective of the present invention is to provide a light guide plate and a method for fabricating the same, so as to improve industrial applicable value thereof.

A further objective of the present invention is to provide a light guide plate and a method for fabricating the same, so as to improve design flexibility.

In accordance with the foregoing and other objectives, the present invention proposes a light guide plate and a method for fabricating the same. The light guide plate is applicable to a backlight module having a backlight source. The light guide plate is characterized in that at least an arc-shaped first opening portion is provided, and a concave lens structure is formed on an edge of the first opening portion or between any two of the adjacent first opening portions at a position corresponding to a light source, such that the concave lens can direct light and achieve a uniform light dispersion effect.

In a preferred embodiment, the first opening portion is a hole or a recessed cavity. The first opening portion can also be a circle or an ellipse.

In a preferred embodiment, a linear microstructure having a cross-section of a geometric figure is formed on the edge of the first opening portion, wherein the geometric figure may be a triangle, a rhombus or other polygons.

In a preferred embodiment, at least an arc-shaped second opening portion is further formed on an edge of the light guide plate at a position corresponding to the light source.

In a preferred embodiment, a first light guiding structure is further formed on a bottom of the light guide plate, wherein the first light guiding structure is preferably a plurality of net points.

In a preferred embodiment, a second light guiding structure is respectively formed on a top and a bottom of the light guide plate, wherein the second light guiding structure is preferably a plurality of V-shaped notches.

In a preferred embodiment, a method for fabricating the light guide plate comprises the following steps. First of all, an injection molding substrate is provided. Then, at least a projecting portion is formed on a surface of the injection molding substrate. An injection molding process is subsequently performed using the injection molding substrate. Finally, a mold releasing process is performed, such that a light guide plate having at least an opening portion for forming a concave lens is fabricated.

In a preferred embodiment, the injection molding substrate is selected from a group consisting of a metal mold, a thin copper plate or a stainless steel plate plated with electroless nickel.

In a preferred embodiment, a method for forming the projecting portion comprises the following steps. First of all, at least an opening is formed on the injection molding substrate. Then, a pillar is inserted in the opening, wherein the pillar protrudes from the surface of the injection molding substrate to form the projecting portion.

In a preferred embodiment, the opening is formed by a mechanical processing method, wherein the opening is preferably a hole or a recessed cavity.

In another preferred embodiment, a method for forming the projecting portion comprises the following steps. First of all, a photoresist layer is formed on the injection molding substrate. Then, a photolithographic process is performed to define any desirable patterns on the photoresist layer. Finally, an electroplating process is performed on the foregoing pattern, such that at least a metal pillar is formed to serve as the projecting portion.

In a preferred embodiment, the projecting portion has an arc shape.

In a preferred embodiment, the projecting portion is selected from a circle or an ellipse.

In a preferred embodiment, at least a projecting portion having an arc-shaped structure is further formed on an edge of the injection molding substrate.

As a fine concave lens structure can be preferably fabricated on a light source incidence surface of the light guide plate and in an interior of the light guide plate, after the light source such as a light emitting diode (LED) propagates through the concave lens structure, the light source is uniformly dispersed to all directions because of light dispersion characteristics of the concave lens structure. Therefore, the prior-art drawback of light output non-uniformity caused by a bright band image is eliminated, so as to improve light output uniformity of the light guide plate.

Furthermore, as the concave lens structure is able to eliminate a total reflection phenomenon, the prior-art problem where light can only be directed by the same incident angle, resulting in light output non-uniformity on other portions of the light guide plate is solved. And a light guide plate with complex structures can still be fabricated by the present invention without hassles of actual fabrication difficulties associated with the prior art, and the light guide plate can be extensively applied in industry. Additionally, the structure and method proposed in the present invention may include various embodiments and the light guide plate is designed and fabricated depending on practical requirements.

Therefore, the light guide plate and the method for fabricating the same proposed in the present invention can achieve a light guiding and a uniform light dispersion effect while saving the fabrication cost, so that prior-art drawbacks such as light output non-uniformity, a high cost, a dramatic loss of light energy and a low utilization value in production can be eliminated. Thus, the present invention is capable of improving the light dispersion effect of the light guide plate and product quality while increasing design flexibility and industrial applicable value thereof.

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

### BRIEF DESCRIPTION OF THE DRAWINGS

The present invention can be more fully understood by reading the following detailed description of the preferred embodiments, with reference made to the accompanying drawings, wherein:

FIG. 1 and FIG. 1A are schematic diagrams showing a light guide plate according to the first embodiment of the present invention;

FIG. 2A through to FIG. 2E are schematic diagrams showing a method for fabricating the light guide plate according to the first embodiment of the present invention;

FIG. 3A is a schematic diagram showing a light guide plate according to the second embodiment of the present invention;

FIG. 3B through to FIG. 3E are schematic diagrams showing the light guide plate according to the third embodiment of the present invention, wherein each of the light guide plates is a modification from the light guide plate shown in the second embodiment;

FIG. 4A through to FIG. 4F are schematic diagrams showing a method for fabricating the light guide plate according to the second embodiment of the present invention;

FIG. 5 is a schematic diagram showing the light guide plate according to the fourth embodiment of the present invention;

FIG. 6A and FIG. 6B are schematic diagrams showing the light guide plate according to the fifth embodiment of the present invention;

FIG. 7 is a schematic diagram showing the light guide plate according to the sixth embodiment of the present invention;

FIG. 8 is a schematic diagram showing a conventional light guide plate described in the prior-art;

FIG. 9 is a schematic diagram showing another conventional light guide plate described in the prior-art;

FIG. 10A and FIG. 10B are schematic diagrams showing the conventional light guide plate according to U.S. Pat. No. 6,568,822 B2; and

FIG. 11 is a schematic diagram showing the conventional light guide plate according to U.S. Pat. No. 6,139,163.

### DETAILED DESCRIPTION OF THE EMBODIMENTS

The light guide plate and method for fabricating the same are applicable to a backlight module. Since the structure and operating mechanism of the backlight module are already known in the prior-art the details thereof are not further described herein. Also, the figures relevant to the backlight module are omitted.

### The First Embodiment

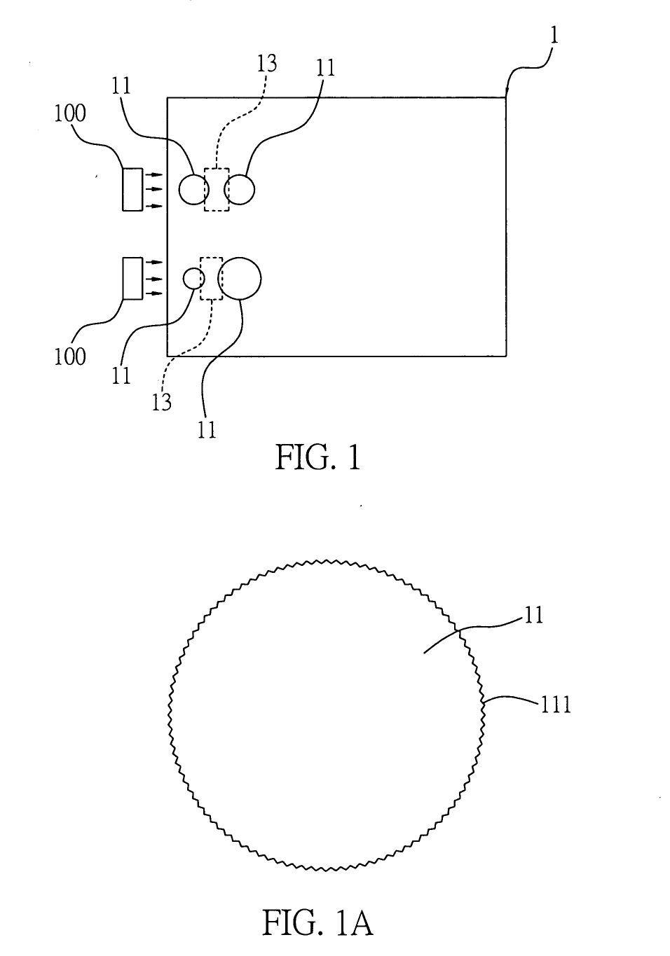

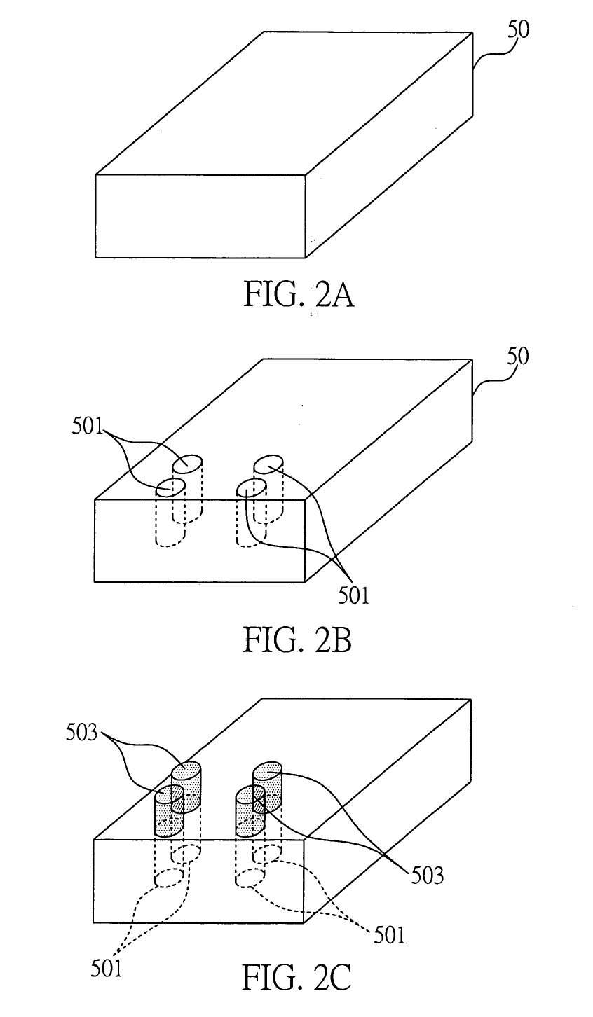

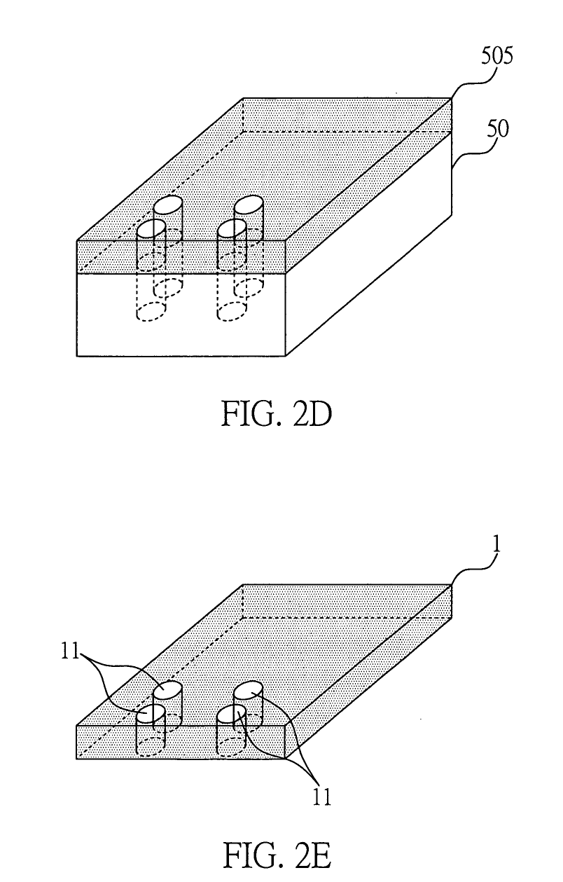

FIG. 1 through to FIG. 2E are schematic diagrams showing a light guide plate and its fabricating method according to the first embodiment of the present invention. Referring to FIG. 1, a light guide plate 1 is provided with a plurality of arc-shaped first opening portions 11.

In the present embodiment, the light guide plate 1 may be made of a transparent acrylic sheet with a preferred refraction index. Four arc-shaped first opening portions 11 are provided on edges of the light guide plate 1 at positions corresponding to a light source 100 which can be a light emitting diode (LED). Each of the arc-shaped first opening portions 11 can be a circle structure, and a concave lens 13 is formed between two of the adjacent first opening portions 11. Each of the first opening portions 11 can be a hole or a recessed cavity, and dimensions and distances between the first opening portions 11 can be varied from each other as shown in FIG. 1.

Furthermore, the number of the first opening portions 11 and their locations are not limited by those described in the present embodiment. For example, additional first opening portions 11 can be provided to form a successive concave lens array (described later). Alternatively, the first opening portion 11 can be located at an end distal from incidence of the light source 100, such that the light source 100 is subjected to another dispersion at a terminal end of the light guide plate 1. Additionally, more than one first opening portion 11 can be provided at the end distal to the incidence of the light source 100.

As the concave lens 13 has a light dispersion property, light beams emitted from the light source 100 can be dispersed by the concave lens 13, so as to destroy a total reflection phenomenon for the light source. So, even a beam of parallel lights traveling in the same direction may have different incident angles since these lights enter the concave lens structure 13 at different positions and reach different curved surfaces. Thus, the reflected lights also travel towards different directions, achieving a non-directional uniform dispersion effect so as to produce a uniform image.

When the light source 100 is dispersed by the concave lens 13 arranged in an array, the light source 100 can be dispersed in all directions and with wider angles. Therefore, this solves the conventional problem of non-uniform image produced when using the LED as the light source and improves the product quality.

FIG. 2A through to FIG. 2E are schematic diagrams showing the method for fabricating the light guide plate according to the present invention.

Referring to FIG. 2A, an injection molding substrate 50 is provided. The injection molding substrate 50 may be selected from, but is not limited to, a group consisting of a metal mold, a thin copper plate or a stainless steel plate plated with electroless nickel.

Next, referring to FIG. 2B, holes are drilled in the injection molding substrate 50 by a mechanical processing method, such that at least two openings are formed therein. As illustrated in FIG. 2B, four holes 501 are formed with no intent to limit the invention by those described in the present embodiment. Alternatively, recessed cavities may be formed in place of the holes.

Referring to FIG. 2C, a projecting portion 503 is formed in each of the holes 501. Preferably, a cylindrical pillar is inserted into each of the holes 501 and protruded from a surface of the injection molding substrate 50 according to the present invention. The pillar can be, but is not limited to, a metal bar. Additionally, the pillar can be of a size with different thickness depending on a size of the first opening portion 11.

Referring to FIG. 2D, an injection molding process is performed, such that a mold 505 of the light guide plate 1 is formed on the surface of the injection molding substrate 50. Since the technique of the injection molding process is well known in the prior-art, the details thereof are not further described herein.

Subsequently, referring to FIG. 2E, a mold releasing process is performed, such that the light guide plate 1 having a plurality of arc-shaped first opening portions 11 is formed.

In the present embodiment, a surface of the mold 505 is level with each of the projecting portions 503. As the projecting portion 503 is a fine cylinder, the first opening portion 11 formed as such has a circular opening. Alternatively, the surface of the mold 505 may optionally cover each of the projecting portions 503 to form the first opening portion 11 such as a recessed cavity. The shapes and materials of the projecting portion 503 are not limited to those described in the present embodiment and may be modified depending on practical requirements.

In comparison to a prior-art technique which employs two molds to perform the injection molding process and requires a relatively higher cost, the present invention employs only one injection molding substrate 50 to perform the process and thus simplifies the fabrication method. Thus, the present invention not only reduces the cost but also eliminates prior-art drawbacks.

Referring to FIG. 1A, a linear microstructure 111 having a triangular cross-section can be further formed on an edge of the first opening portion 11 (a circumferential surface) according to the first embodiment. The linear microstructure 111 is designed to further improve uniformity of the light dispersion. The cross-section of the linear microstructure 111 is not limited to a triangle, and can also includes a rhombus or other polygons, as long as the design of the geometric figures facilitates the mold releasing.

### The Second Embodiment

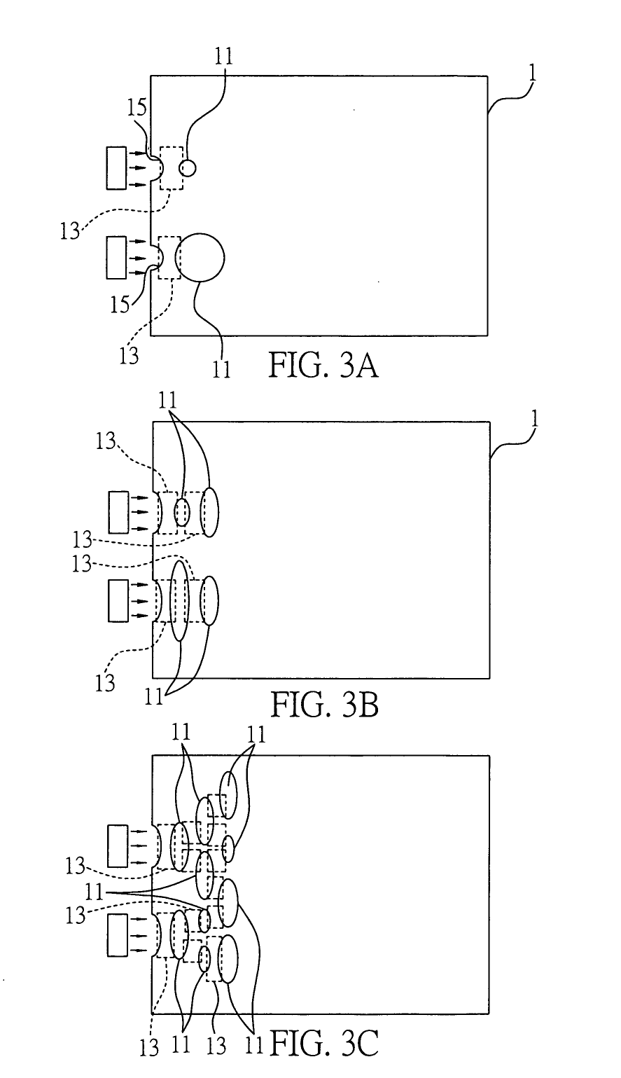

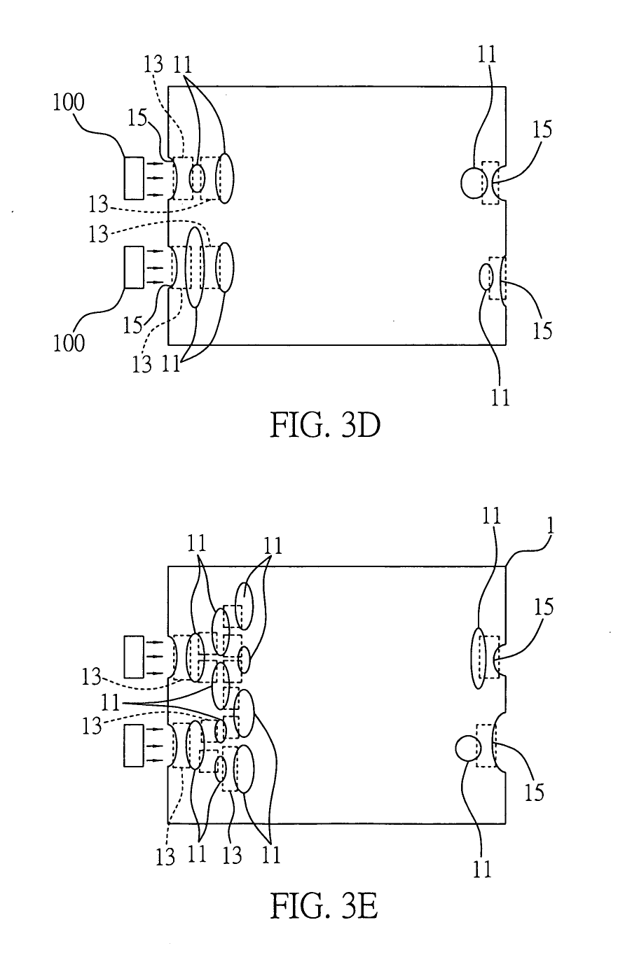

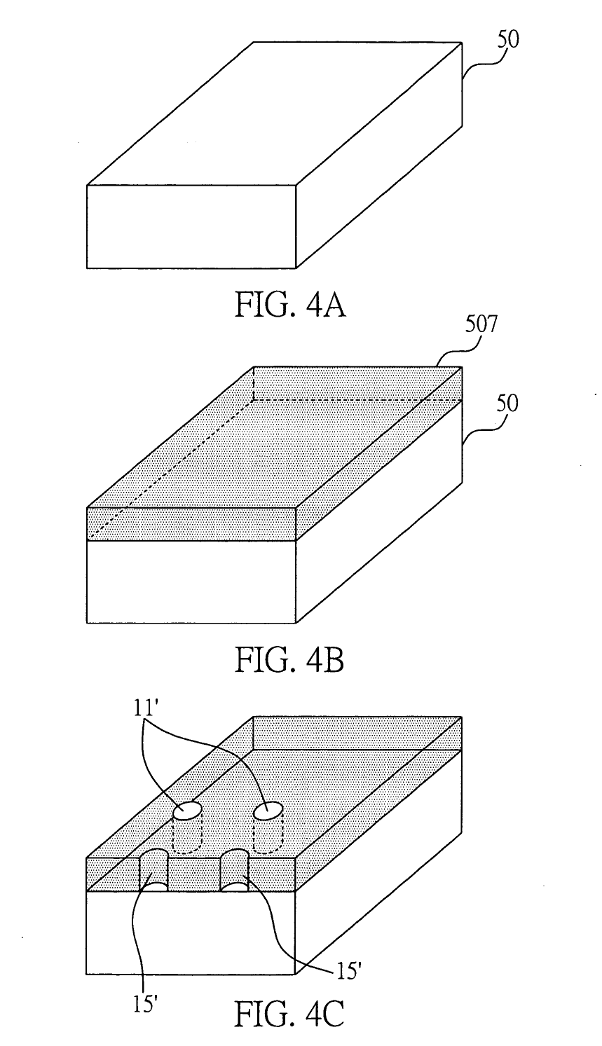

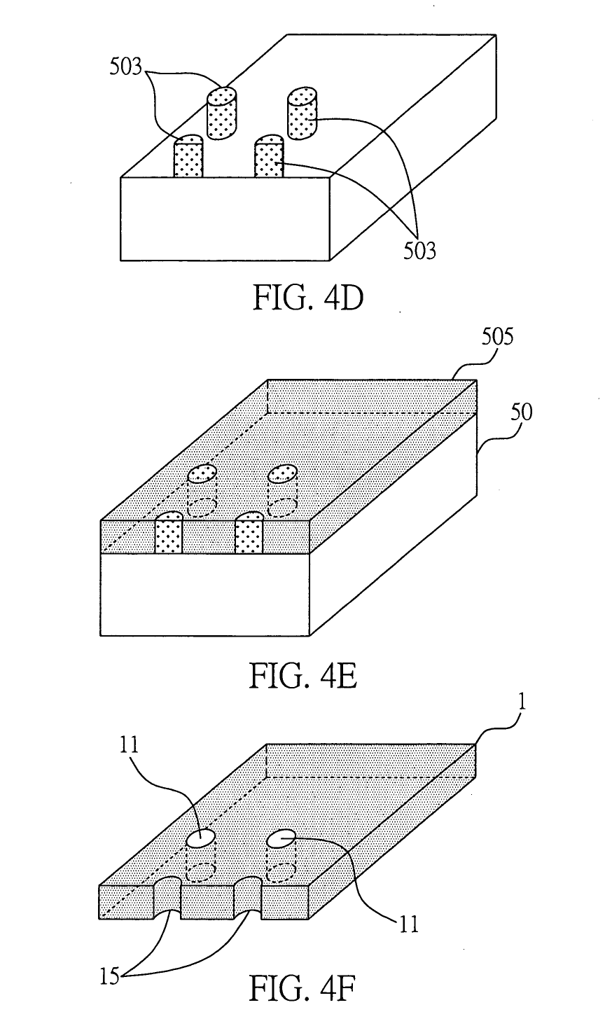

FIG. 3A and FIG. 4A through to FIG. 4F are schematic diagrams showing the light guide plate and method for fabricating the same according to the second embodiment of the present invention. In order to provide a clearer description for the present invention, elements in this embodiment consistent or similar to that in the first embodiment are illustrated using the same or similar reference numerals and their details are not further described.

As illustrated in FIG. 3A, the second embodiment differs from the first embodiment in that a plurality of arc-shaped second opening portions 15 is formed on an edge of the light guide plate 1 at positions corresponding to the light source 100, and each of the first opening portions 11 has a size different from each other.

Therefore, each of the concave lens 13 can be formed on the edge of the light guide plate 1, such that a propagated light source of the light source 100 is uniformly dispersed to different directions to improving uniformity of the light output from the light guide plate 1.

In the present embodiment, FIG. 4A through to FIG. 4F are schematic diagrams showing the method for fabricating the light guide plate proposed in the present invention.

Referring to FIG. 4A, an injection molding substrate 50 such as the one shown in FIG. 2A is provided.

Next, referring to FIG. 4B, a photoresist layer 507 is formed on the injection molding substrate 50. The photoresist layer 507 can be made of, but is not limited to, a mixture of resins, sensitizers and solvents mixed according to different constituting ratios of these components.

Referring to FIG. 4C, a photolithographic process is performed to define desirable patterns 11′ and 15′ on the photoresist layer, so as to form a plurality of openings. In the present embodiment, the patterns 11′ and 15′ are equivalent to the hole 501 in the foregoing embodiment. In other words, the patterns 11′ and 15′ are formed to correspond with the first opening portion 11. A predetermined pattern is shifted onto the photoresist layer 507 by the photolithographic process which involves exposing, developing and baking processes which are all known in the prior-art and are not further described.

Then, referring to FIG. 4D, an electroplating process is performed to form a plurality of projecting portions 503. In the present embodiment, the electroplating process is performed on the foregoing patterns 11′ and 15′ equivalent to the hole, such that the projecting portion 503 is formed on the surface of the injection molding substrate 50. The projecting portion 503 can be, but is not limited to a metal pillar. And each of the projecting portions 503 has a dimension and shape different from each other. Alternatively, in other embodiments, the dimension and shape of each of the projecting portions 503 can be the same.

Referring to FIG. 4E, an injection molding process is performed to form the mold 505 of the light guide plate 1 on the surface of the injection molding substrate 50.

Subsequently, referring to FIG. 4F, a mold releasing process is performed, such that the light guide plate 1 having a plurality of arc-shaped first opening portions 11 and arc-shaped second opening portions 15 is formed.

The present embodiment is similar to the first embodiment in that only one injection molding substrate 50 is required, to solve not only problems associated with the prior art, but also improve product quality of the light guide plate. Therefore, it is easier to fabricate a more complex, finer and irregular opening portion, and form a micro concave lens structure free of difficulties encountered during conventional fabrication.

### The Third Embodiment

FIG. 3B through to FIG. 3E are schematic diagrams showing modifications of the foregoing embodiments. The elements similar to those described in the foregoing embodiment are illustrated by the same or similar reference numerals and not further described in details, except for the modifications to further define the technical feature of the present invention.

Referring to FIG. 3B, the circular hole of the first opening portion 11 shown in the second embodiment is modified to be an elliptical hole or recessed cavity. In the light guide plate 1 in the present embodiment, curvature values of two curved surfaces of the first opening portion 11 having an elliptical shape can be determined by the angle of the light source divergence desired. The curvature value of each of the two curved surfaces of the first opening portion 11 can differ from each other. Further, the size and distance between the first opening portions 11 can be different from each other.

Referring to FIG. 3C, the first opening portion 11 arranged in two rows in the foregoing embodiment is modified to be a structure with a three-row arrangement. Thus, an array of successive concave lens 13 is formed. Alternatively, the first opening portion 11 and the concave lens 13 can be specifically arranged depending on practical requirements.

Referring to FIG. 3D, the first opening portion 11 and the second opening portion 15 shown in the foregoing embodiment are modified to be located both on an edge of the light guide plate 1 at a position corresponding to the light source 100 and at a distal end of the light guide plate 1 in line with incidence of the light source 100. The first opening portion 11 can be a hole or a recessed cavity having a circular or elliptical shape. Therefore, a plurality of microstructures with different curvatures is formed to improve a light dispersion effect of the light source 100.

Referring to FIG. 3E, the structures shown in FIG. 3B to FIG. D are integrated, such that the first opening portion 11 and the second opening portion 15 are formed both on the edge of the light guide plate 1 at the position corresponding to the light source 100 and at the distal end of the light guide plate 1 in line with the incidence of the light source 100, so as to form the array of the successive concave lens 13. The first opening portion 11 can be a hole or a recessed cavity having a circular or elliptical shape. Therefore, the structure and location of the first opening portion 11, the concave lens 13 and the second opening portion 15 can be determined more flexibly according to desirable dispersion directions of the light source and the intensity of the light being redirected into each direction.

### The Fourth Embodiment

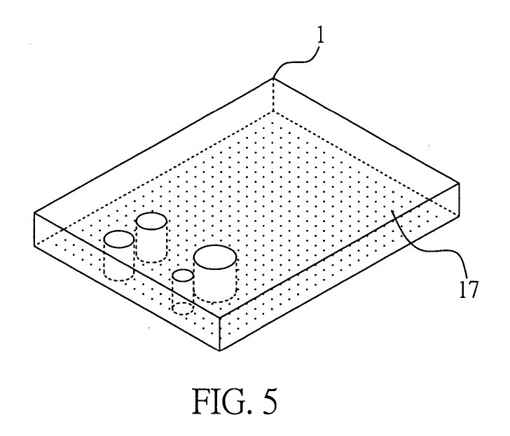

FIG. 5 is a schematic diagram showing the light guide plate according to the fourth embodiment of the present invention. The elements similar to those described in the foregoing embodiment are illustrated by the same or similar reference numerals and only differences are described to emphasize the technical feature of the present invention.

The fourth embodiment differs from the foregoing embodiment in that a first light guiding structure 17 is formed on a bottom of the light guide plate 1.

In the present embodiment, the first light guiding structure 17 may be a plurality of net points. In other words, apart from the first opening portion 11 and/or the second opening portion 15 described in the foregoing embodiment, light beams emitted from the light source 100 can be also dispersed by the first light guiding structure 17 and output from a top of the light guide plate 1. Thus, a light dispersion effect and light output uniformity can be improved.

### The Fifth Embodiment

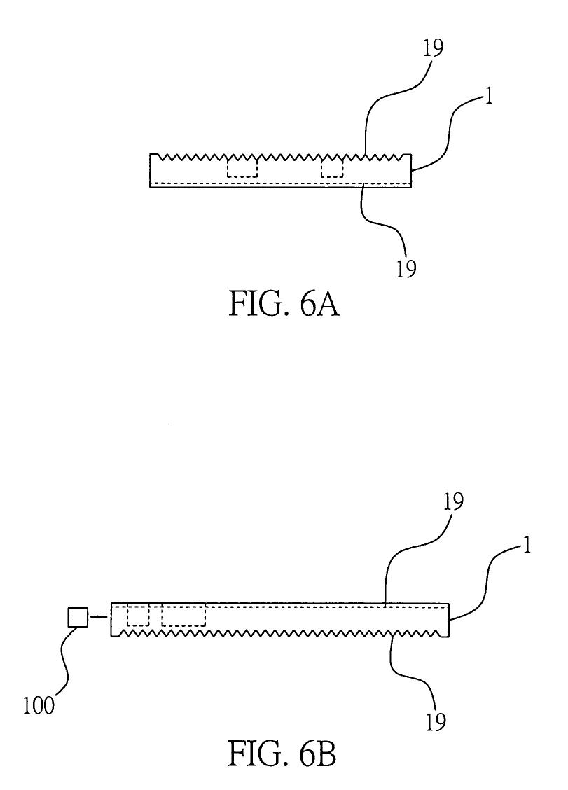

FIG. 6A and FIG. 6B are schematic diagrams showing the light guide plate according to the fifth embodiment of the present invention. FIG. 6A and FIG. 6B illustrate a top view and a side view of the light guide plate 1, respectively.

The fifth embodiment differs from the foregoing embodiment in that a second light guiding structure 19 is respectively formed on a top and a bottom of the light guide plate 1.

Referring to FIG. 6A and FIG. 6B, the second light guiding structure 19 can be a plurality of V-shaped notches in the present embodiment. The second light guiding structure 19 formed on the top of the light guide plate 1 is parallel to an incident direction of the light source 100 whereas the second light guiding structure 19 formed on the bottom of the light guide plate 1 is perpendicular to the incident direction of the light source 100. In other words, the second light guiding structure 19 formed on the top of the light guide plate 1 is perpendicular to the second light guiding structure 19 formed on the bottom of the light guide plate 1.

Accordingly, the light source can be uniformly dispersed to all directions by the concave lens structure or the array of the concave lens formed on a light incidence surface of the light guide plate 1 and in an interior of the light guide plate 1, respectively. And a bright band image can be eliminated even though the bottom of the light guide plate is formed with V-shaped notches. Furthermore, light beams emitted from the light source 100 can be also dispersed by the second light guiding structure 19 formed on the bottom of the light guide plate 1 and output from the top of the light guide plate 1. Light from the bottom can be concentrated by the second light guiding structure 19 formed on the top of the light guide plate 1, so as to improve light output brightness.

### The Sixth Embodiment

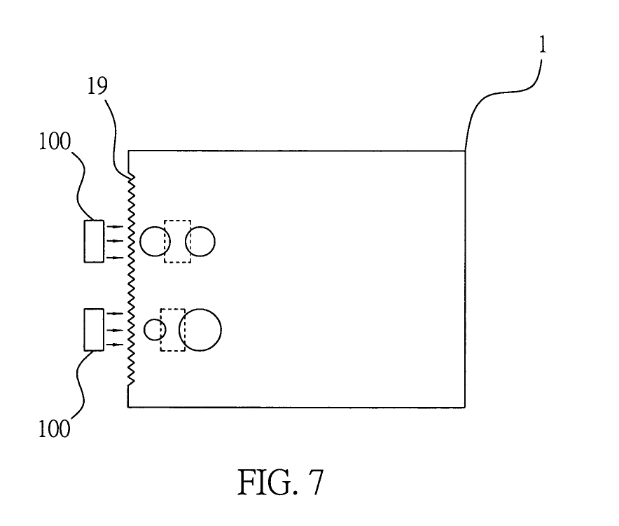

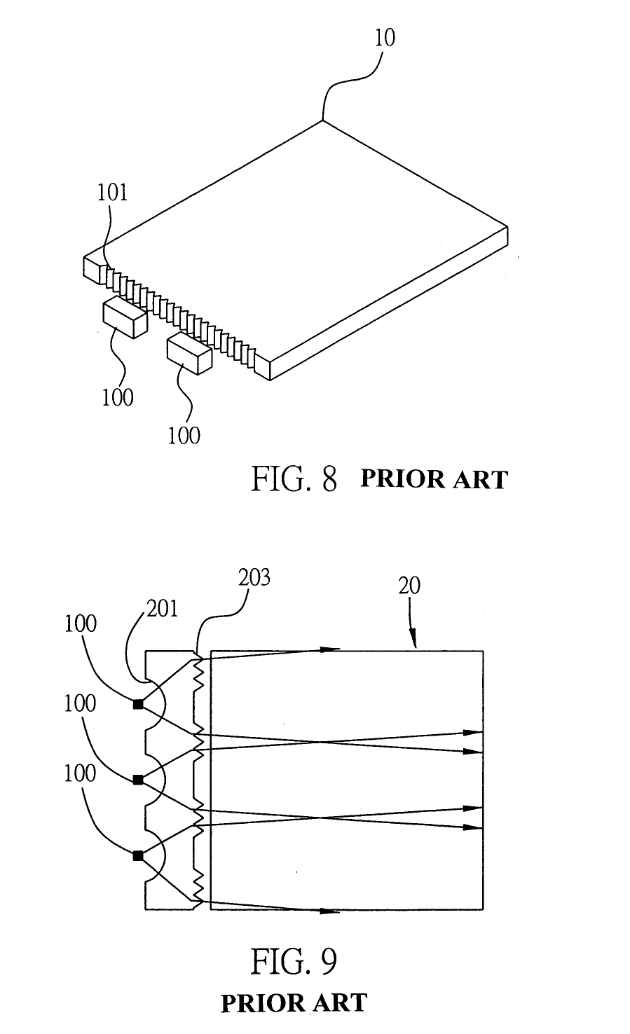

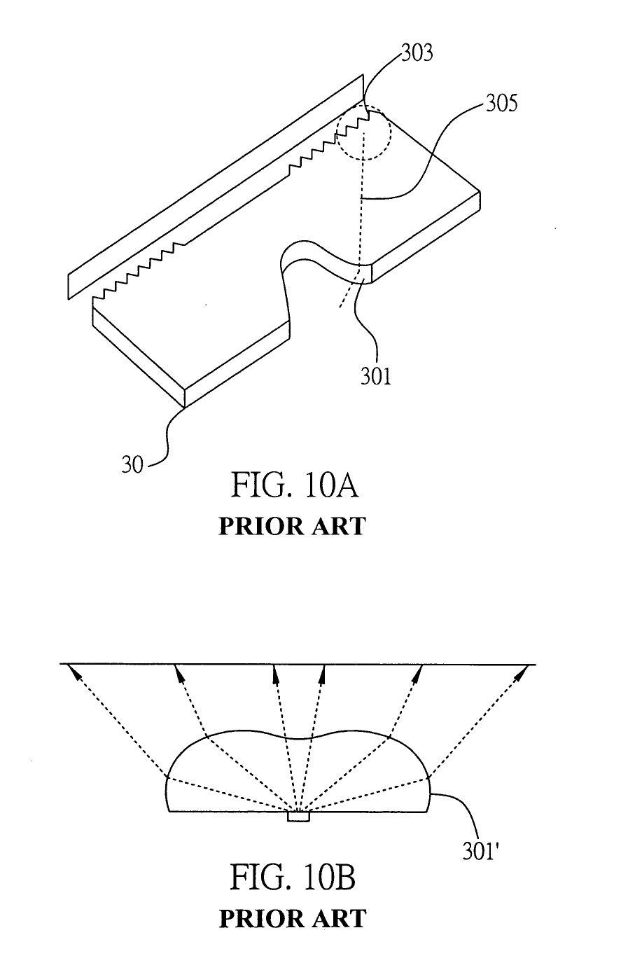

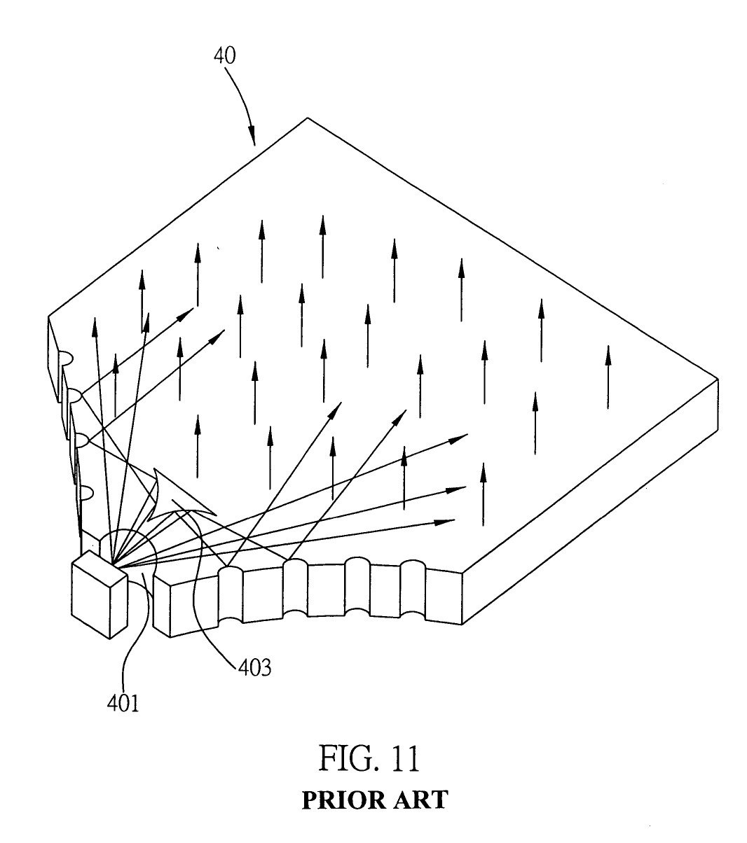

FIG. 7 is a schematic diagram showing the light guide plate according to the sixth embodiment of the present invention.

Referring to FIG. 7, the second light guiding structure 19 formed on the top and bottom of the light guide plate 1 is re-located on an edge of the light guide plate 1 at a position corresponding to the light source 100 in the present embodiment.

Accordingly, the light guide plate and the method for fabricating the same proposed in the present invention can be designed with more flexibility and various embodiments. Also, the elements described in each of the previous embodiments can be interchanged by each other. For example, the second light guiding structure 19 in the sixth embodiment may also be included in any embodiment from the first embodiment to the fifth embodiment. The fabrication methods in the first embodiment and the second embodiment can be also replaced by each other. The second opening portion 15 in the second embodiment can be replaced by the first opening portion 11 with an arc shape structure formed in the edge of the light guide plate 1 at the position corresponding to the light source 100 in the first embodiment. Therefore, the present invention may be modified based on different views and applications without departing from the spirit of the invention.

For example, only one first opening portion 11 is formed on the light guide plate 1 to sufficiently allow formation of the concave lens 13 on an edge of the first opening portion 11 at a position corresponding to the light source 100, in order to meet the requirement of various dimension specifications, such that a single-side concave lens opposite to the light source 100 is formed. Such modification only differs from each of the foregoing embodiments in the number of the first opening portion 11 formed. The single- or double-surface concave lenses formed as such are both covered by the scope of the concave lens 13 and thus are not further described.

Therefore, the light guide plate and the method for fabricating the same proposed in the present invention can disperse light beams emitted from the light source into different directions and achieve a uniform light dispersion effect and further save the fabrication cost. Furthermore, while the method proposed in the present invention is simplified, the industrial applicability thereof is effectively improved, so as to eliminate prior-art drawbacks.

Additionally, the actual number of the opening portions formed and their locations in the light guide plate and the method for fabricating the same proposed in the present invention are not limited by the foregoing embodiments, and can be modified depending on practical requirements and easily understood by one having ordinary skills in the pertinent art.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A light guide plate applicable to a backlight module having a light source, the light guide plate being formed with at least an arc-shaped first opening portion, such that a concave lens structure is formed on an edge of the first opening portion so as to be arranged to be in line with the light source, so that the concave lens structure can direct light and achieve a uniform light dispersion effect.

2. The light guide plate of claim 1, wherein when a plurality of first opening portions are formed, the concave lens structure is formed between any two adjacent first opening portions so as to be arranged to be in line with the light source.

3. The light guide plate of claim 1, wherein the first opening portion is formed in a shape selected from a hole and a recessed cavity.

4. The light guide plate of claim 1, wherein the first opening portion is formed in a shape selected from a circle and an ellipse.

5. The light guide plate of claim 1, wherein an edge of the first opening portion is formed with a linear microstructure having a cross-section of a geometric figure.

6. The light guide plate of claim 5, wherein the geometric figure is selected from a group consisting of a triangle, rhombus and polygon.

7. The light guide plate of claim 1, wherein at least an arc-shaped second opening portion is further formed on the edge of the light guide plate at a position corresponding to the light source.

8. The light guide plate of claim 1, wherein a first light guiding structure is further formed on a bottom portion of the light guide plate.

9. The light guide plate of claim 8, wherein the first light guiding structure comprises a plurality of net points.

10. The light guide plate of claim 1, wherein a second light guiding structure is respectively formed on a top portion and the bottom portion of the light guide plate.

11. The light guide plate of claim 10, wherein the second light guiding structure comprises a plurality of V-shaped notches.

12. A method for fabricating a light guide plate, comprising steps of:
providing an injection molding substrate;
forming at least a projecting portion on a surface of the injection molding substrate;
performing an injection molding process using the injection molding substrate; and
performing a mold releasing process, such that the light guide plate is formed to have at least an opening portion for forming a concave lens structure.

13. The method of claim 12, wherein the injection molding substrate is selected from a group consisting of a metal mold, a thin copper plate and a stainless steel plate plated with electroless nickel.

14. The method of claim 12, wherein the step of for forming the projecting portion comprises:
forming at least an opening in the injection molding substrate;
inserting a pillar in the opening; and
protruding the pillar from the surface of the injection molding substrate for forming the projecting portion.

15. The method of claim 14, wherein the opening is formed by a mechanical processing method.

16. The method of claim 14, wherein the opening is formed in a shape from a hole or a recessed cavity.

17. The method of claim 12, wherein the step of forming the projecting portion comprises:
forming a photoresist layer on the injection molding substrate;
performing a photolithographic process, such that desirable patterns are defined on the photoresist layer; and
performing an electroplating process on said patterns, so that at least a metal pillar is formed to serve as the projecting portion.

18. The method of claim 12, wherein the projecting portion is in an arc shape.

19. The method of claim 12, wherein the projecting portion is formed in a shape selected from a circle and an ellipse.

20. The method of claim 12, further comprise forming at least a arc-shaped projecting portion on an edge of the injection molding substrate.
